(19) United States
(12) Patent Application Publication
(10) Pub. No.: US 2007/0059528 A1
(43) Pub. Date: Mar. 15, 2007

(54) Low resin demand foundry media

(75) Inventors: Thomas C. Palamara, Eufaula, AL (US); Brett Allen Wilson, Lafayette, LA (US)

Correspondence Address: HAYNES AND BOONE, LLP, 901 MAIN STREET, SUITE 3100, DALLAS, TX, 75202, US

(73) Assignee: CARBO Ceramics Inc., Irving, TX (US)

(21) Appl. No.: 11/297,582

(22) Filed: Dec. 8, 2005

Related U.S. Application Data
(60) Provisional application No. 60/634,185, filed on Dec. 8, 2004.

(51) Int. Cl. B32B 15/02; B29C 33/40; C04B 35/64

(52) U.S. Cl. 428/404; 264/219; 264/669; 264/679

(57) ABSTRACT

Foundry media having a low surface porosity and methods for producing the media are disclosed. One method includes minimizing a moisture content of the media prior to sintering the media, which minimized moisture content minimized the surface porosity of the sintered media. The media can be coated with resin, and a mold made therefrom. The media requires less resin than conventional media because of the low porosity, and stronger molds can be made from the media.

### CROSS-REFERENCE

This application is a non-provisional of U.S. patent application Ser. No. 60/634,185, filed on Dec. 8, 2004, entitled “Low Resin Demand Foundry Media”, which is incorporated by reference herein in its entirety.

### BACKGROUND

Foundry media typically used in metal casting by the foundry industry includes naturally occurring sands as a primary component in molding operations. The foundry media is typically coated with a resin, such as a hydrocarbon resin, or other means in order to provide the media with sufficient strength for retaining its shape after a mold has been formed therefrom. The amount of resin required to coat the foundry media such that the media has sufficient strength to retain its shape once molded has an influence on the overall cost of the molding operation. The strength of the formed molds also affects the molds' ability to retain its shape during casting operations, which in turn affects the overall cost of casting operations. High resin levels increase cost and can lead to defects formed from excessive gas created by resin burn out during casting.

Thus, it is desirable to provide a foundry media that minimizes the amount of resin applied thereto, while retaining strength in molds formed from the foundry media.

### BRIEF DESCRIPTION OF DRAWINGS

FIG. 1 illustrates tensile strength of objects made from foundry media as described herein and having varying amounts of surface porosity.

FIG. 2 illustrates tensile strength of objects made from foundry media as described herein, and having varying amounts of surface porosity and being coated with varying amounts of resin.

FIG. 3 illustrates tensile strength of objects made from foundry media as described herein, and having varying amounts of surface porosity and being coated with varying amounts of resin.

### DETAILED DESCRIPTION

According to certain embodiments described herein, methods for making a foundry media with a reduced resin requirement are described. The foundry media comprises substantially round and spherical sintered pellets formed from calcined, partially calcined, or uncalcined kaolin clay, diaspore clay, burley clay, flint clay, bauxite and alumina, or mixtures thereof. In general, the foundry media can be made from any aluminosilicate material that will pelletize into spherical particles, and that can be dried and sintered to form a final pellet having desired properties, such as those described herein.

According to one embodiment, porosity on the surface of the foundry media is controlled such that the absorption of resin by pores on the surface of the foundry media is minimized. According to some such embodiments, the lower the surface porosity of the foundry media, the greater the tensile strength of objects formed from the media, for example, dog bones, molds and casting cores. Thus, there is an inverse relationship between the surface porosity of the foundry media and the strength of the object made therefrom. The strength of the object is due to less absorption of resin by pores in the media, thereby leaving more resin on the surface of the media to contribute to the strength of the object formed therefrom. Moreover, objects formed from such foundry media can have the same or greater strength than the strength of objects formed from conventional foundry media, and can require less resin to form such objects than conventional foundry media. The lower resin requirement of the present foundry media, as compared to conventional foundry media, for the production of objects with strengths equal to or greater than objects formed from conventional foundry media, is made possible by the low surface porosity of the present foundry media. Thus, there is a direct relationship between the surface porosity of the foundry media and the resin requirement of the media for a given object.

According to another embodiment, the moisture content of the foundry media is controlled prior to sintering the media, such that upon sintering, creation of pores on the surface of the media is minimized. In particular, there is a direct relationship between the moisture content of the foundry media at a dried green state and the surface porosity of the media when sintered. According to certain embodiments, the foundry media is dried, prior to sintering, to a moisture content of less than about 10% by weight, less than about 6% by weight, less than about 5% by weight, or less than about 2% by weight of moisture remaining in the green pellets comprising the foundry media. According to still other embodiments, the moisture content of the green pellets is controlled by controlling the residence time of the pellets in a dryer, and/or controlling the operating temperature of the dryer, and/or controlling the air velocity of the dryer, and/or providing a substantially uniform rate of feed of green pellets to the dryer.

According to yet another embodiment, sintering of dried green pellets is performed by controlling the initial rate of heating of the pellets upon entry into sintering equipment such that the initial heating of the pellets is slower than it would be if the initial rate of heating was not controlled. According to one such embodiment, the pellets are heated in the sintering equipment at an initial rate of about 16° C./min, up to an initial temperature of at least about 250° C. After initial heating, the heating rate can be increased, up to sintering temperatures suitable for sintering the pellets to a final state. According to other embodiments, the initial rate of heating can be greater than or less than 16° C./min. In still other embodiments, an initial temperature is selected, and the initial rate of heating per minute is about 2 to about 10% of the initial temperature.

According to other embodiments for controlling the initial rate of heating of the pellets, the exit air temperature of the sintering equipment, for example a rotary kiln, is maintained at a temperature of about 600° C. (1112° F.) or less, or at a temperature that is no more than 40% of the peak sintering temperature. The exit air temperature is the temperature that the material is exposed to upon entry to the sintering equipment. The use of a controlled initial heating rate during sintering can be combined with the methods described herein for drying the pellets to a targeted moisture content prior to sintering.

According to still other embodiments, the foundry media is sintered, and the sintered media has a surface porosity of between about 1.0% and about 4.0% by volume of the pellets comprising the foundry media. In some embodiments, the sintered media has a surface porosity between about 1.3% and 3.0% by volume of the pellets comprising the foundry media. In still other embodiments, the sintered media has a surface porosity of less than about 1% by volume.

Also described herein are products comprising substantially round and spherical sintered pellets comprising an aluminosilicate material, and having a surface porosity of less than about 3% by volume. Such products can be the pellets themselves, which are suitable for use as a foundry media, or the products can be objects made from the pellets, such as a mold or dog bone relevant to the foundry industry.

The following examples are illustrative of the methods and compositions discussed above.

### EXAMPLE 1

A raw material comprising calcined kaolin clay having an alumina content of from about 45% to about 51% by weight, a silica content of from about 45% to about 51% by weight, an iron content of from about 0.8% to about 1.9% by weight, and a balance of other compounds (e.g., TiO₂, ZrO₂, CaO, MgO and K₂O) was continuously fed to a ball mill, along with a feed of starch. The starch was added to the ball mill at a rate to maintain a percentage based on the weight of the raw material in the mixer of about 0.70%. The starch served as a binder to improve the formation of pellets.

The raw material (with the starch mixed therein) was then fed periodically to a high intensity mixer commercially available from Eirich Machines, Inc. in amounts of about 300 pounds at a time. The mixer had a rotatable impacting impeller that can rotate at a tip speed of from about 5 to about 50 meters per second. The mixer also had a circular table that can rotate at a speed of from about 10 to about 60 revolutions per minute (rpm), and can be operated in a horizontal or inclined configuration, with an incline up to 35 degrees from horizontal. The direction of rotation of the table is opposite that of the impeller, causing material added to the mixer to flow over itself in countercurrent manner.

For this example, the table was rotated at from about 20 to about 40 rpm, at an incline of about 30 degrees from horizontal. During the addition of the first half of the amount of water, the impacting impeller was rotated at about 16 meters per second (about 568 rpm), and was thereafter rotated at a higher tip speed of about 32 meters per second (about 1136 rpm).

Water was continuously added to the mixer in an amount sufficient to cause formation of substantially round and spherical pellets. The rate of water addition to the mixer is not critical. The intense mixing action disperses the water throughout the particles. In this particular example, the water was fresh water, which was continuously fed to the mixer in an amount sufficient to maintain a percentage based on the weight of the raw material in the mixer from about 18 weight % to about 22 weight %.

After about 2 to about 6 minutes of mixing, substantially round and spherical pellets of approximately the desired size are formed. Desired fired pellet size in this example was between about 16 and about 270 U.S. Mesh after sintering, or expressed as microns, between about 1180 and 53 microns after sintering. Sintering will generally cause the pellets to shrink from about 1 to about 2 U.S. Mesh sizes. Once pellets of approximately the desired size were formed, additional raw material was added to the mixer in an amount of about 10 weight percent, and the mixer speed was reduced to about 16 meters per second (about 568 rpm). Mixing was continued at the slower speed for about 1 to about 60 seconds, and then the pellets were discharged from the mixer.

After discharge from the mixer, the pellets were dried. In the present example, the pellets were continuously fed to a rotary dryer at approximately uniform rates. To accomplish the approximately uniform rate of feed, a plow-type device (also known as a doctor blade) was used to level out the body of pellets being fed to the dryer. The leveling of the pellets resulted in the pellets entering the dryer as a continuous flattened bed of material relative to a periodic mound of material.

The dryer was operated at a temperature ranging from about 100° C. (212° F.) to about 300° C. (572° F.). The pellets had a residence time in the dryer in the present example of about 45 minutes, although the amount of residence time can be in the range of from about 15 to about 60 minutes. The air velocity through the dryer was controlled so as not to entrain small pellets, such as those pellets having a size of about 100 U.S. Mesh or smaller in an air stream flowing to a baghouse (which could be a dust collector), while still providing enough drying air to reduce the moisture of the pellet to a targeted moisture content.

The green pellets (which are referred to as “green” because they have not been fired to their final state) were discharged from the dryer. Samples of the green pellets exiting the dryer were periodically tested for moisture content using a moisture balance, which is a device known to those of ordinary skill in the art. Generally, however, the sample is weighed and then heated to evaporate water from the sample. As water evaporates from the sample, the weight of the sample changes. The test is completed when the weight becomes fairly constant, and the difference in starting weight and end weight is reported as a moisture content of the sample by weight percent. As described further below, the measured moisture contents of the pellets exiting the dryer were evaluated against the porosity of pellets after sintering to their final state.

In this particular example, sintering was performed by feeding the green pellets to a rotary kiln operated at a temperature ranging from about 1,438° C. (2,620° F.) to about 1,466° C. (2,670° F.), for a residence time of about 60 minutes.

After sintering, a sample of the sintered pellets were screened with US mesh sizes in order to determine what grain fineness numbers (GFN) had been produced. The correlation between US mesh sizes and GFN can be determined according to Procedure 106-87-S of the American Foundry Society Mold and Core Test Handbook, which is a text known to those of ordinary skill in the art. In this particular example, it was determined that sintered pellets were produced having a GFN in the range of from about 57 to about 85.

In the present example, the sintered pellets were determined to have a bulk density in the range of from about 1.33 g/cc to about 1.51 g/cc, expressed as a weight per unit volume, including in the volume considered, the void spaces between the pellets. The bulk density was determined for the present example by ANSI Test Method B74.4-1992 (R 2002), which is a text known and available to those of ordinary skill in the art.

In the present example, the sintered pellets were determined to have an apparent specific gravity (ASG) of from about 2.50 to about 2.80. Apparent specific gravity is a number without units, but numerically equal to the weight in grams per cubic centimeter of volume, excluding void space or open porosity in determining the volume. The apparent specific gravity values given herein were determined by the Archimedes method of liquid (water) displacement, a method that is known to those of ordinary skill in the art.

In the present example, the sintered pellets were determined to have a crush strength of from about 2 wt % to about 8.5 wt % fines (i.e., material less than 140 U.S. Mesh) at 5000 psi. The crush values reported herein were determined according to API Recommended Practices RP60 for testing proppants, which is a text known to those of ordinary skill in the art. Generally, however, according to this procedure, a bed of about 6 mm depth of sample that has been screened to contain pellets of 140 U.S. Mesh and larger is placed in a hollow cylindrical cell. A piston is inserted in the cell. Thereafter, a load is applied to the sample via the piston. One minute is taken to reach maximum load, which is then held for two minutes. The load is thereafter removed, the sample removed from the cell, and screened to −140 mesh to separate crushed material. The results (i.e., the amount of “fines”, or crushed material) are reported as a percentage by weight of the original sample.

Tests conducted on samples of the sintered pellets reported an alumina content in a range of from about 47% to about 49% by weight, a silica content of from about 46% to about 48% by weight, an iron oxide content of from about 1.4% to about 1.6% by weight, and a balance of other compounds (e.g., TiO₂, ZrO₂, CaO, MgO and K₂O).

In the present example, the sintered pellets were determined to have a surface porosity in a range of from about 1.2% to about 7.5% by volume. The porosity values were determined by a Mercury Porosimeter at a pressure from 30 to 60,000 psia. A mercury porosimeter is a device whose use is known to those of ordinary skill in the art.

In Example 1, it was determined that 85% of the moisture content values measured for the dried green pellets were greater than 6% by weight, and 49% of the surface porosity measurements on sintered pellets were greater than 3% by volume. Thus, 15% of the moisture values measured for the dried green pellets were less than 6% by weight, and 51% of the surface porosity measurements for sintered pellets were less than 3% by volume.

### EXAMPLE 2

A raw material comprising calcined kaolin clay having an alumina content of from about 45% to about 51% by weight, a silica content of from about 45% to about 51% by weight, an iron content of from about 0.8% to about 1.9% by weight, and a balance of other compounds (e.g., TiO₂, ZrO₂, CaO, MgO and K₂O) was used to prepare sintered pellets according to the method described in Example 1.

The pellets of Example 2 were prepared as described above in Example 1. However, based on the data obtained from Example 1, it was determined that conditions affecting the moisture content of the green pellets should be controlled so that the moisture content would be minimized. Thus, the procedure of Example 1 was modified for this Example 2 as follows: closer monitoring of the rotary dryer to keep the drying temperature and airflow within target ranges, (which were about 100° C. to about 300° C. for drying temperature and the maximum airflow velocity that could be achieved without entraining pellets of about 100 U.S. Mesh); (b) creating green pellets at a rate close to the feed rate for the kiln to provide a more uniform quantity of pellets fed to the rotary dryer, and (c) optimizing the doctor blade height so as to provide a more uniform level of pellets fed to the rotary dryer. Generally, green pellets can be created in larger amounts than can be fed to a kiln at any given time. Controlling the amounts of green pellets being made to amounts closer to the rate that can be fed to the kiln helps to control the amount of green pellets fed to the dryer.

In Example 2, the sintered pellets were determined to have a bulk density in the range of from about 1.40 g/cc to about 1.55 g/cc, expressed as a weight per unit volume, including in the volume considered, the void spaces between the particles; an apparent specific gravity (ASG) of from about 2.65 to about 2.80; a crush strength of from about 1 wt % to about 10 wt % fines at 5000 psi. The bulk density, ASG, and crush were determined as described in Example 1.

In Example 2, the sintered pellets were determined to have a surface porosity in a range of from about 1.3% to about 4.0% by volume. The porosity values were determined as described in Example 1.

In Example 2, it was determined that 6% of the moisture content values measured for the dried green pellets were greater than 6% by weight, and 19% of the surface porosity measurements on sintered pellets were greater than 3% by volume. Thus, 94% of the moisture content values measured for the dried green pellets were less than 6% by weight, and 81% of the surface porosity measurements for sintered pellets were less than 3% by volume.

By comparing the moisture content values of dried green pellets from Examples 1-2, and the porosity of sintered pellets from Examples 1-2, a direct relationship between moisture value of the dried green pellets and the surface porosity of the sintered pellets is revealed. For example, Table 1 illustrates that when more of the dried green pellets had a moisture content less than 6% by weight, then more of the sintered pellets had surface porosity measurements less than 3% by volume.

| | % of Dried Green Pellets | % of Sintered Pellets |
|---|---|---|
| | with Moisture Content | with Surface Porosity |
| Ex. No. | less than 6 Wt. % | less than 3 Vol. % |
| 1 | 15 | 51 |
| 2 | 94 | 81 |

### EXAMPLE 3

Foundry media having low surface porosities as described herein can be used to prepare casting cores. The tensile strength of dog bones formed from pellets made in the lab according to the principles set forth in Examples 1 and 2 indicates that the lower the surface porosity of the pellets, the greater the strength of a casting core formed from the pellets.

The lab made pellets were made from a blend of 98.25% kaolin (K-60 from CE Minerals, Andersonville, Ga.) and 1.75% iron oxide (Dennox from Densimix, Houston, Tex.). The kaolin was calcined to 3% loss on ignition (LOI) before batching and co-milling with the iron oxide. Equipment and methods for jet-milling raw materials such as those described herein are known to those of ordinary skill in the art. In this example, the raw materials were jet-milled in a Sturtevant Inc. 4″ Open Manifold Micronizer using a feed rate of about one pound per hour.

The milled material was then fed to a lab high intensity mixer commercially available from Eirich Machines, Inc., which is sized for feeds of 6-10 pounds at a time. Water was fed to the mixer to form substantially round and spherical pellets as described in Examples 1-2. The formed pellets were discharged from the lab mixer, poured in a stainless steel pan, and placed overnight in a static drying oven operating at 110° C., resulting in pellets having a moisture content of less than about 1% by weight.

The dried green pellets were fired in a lab box kiln. For box kiln firing, the dried green pellets were placed in alumina boats, which were loaded into a box kiln operating and fired to peak temperature with a heating rate of 16° C. per minute, held at peak temperature for 30 minutes and cooled with a cooling rate of 12° C. per minute.

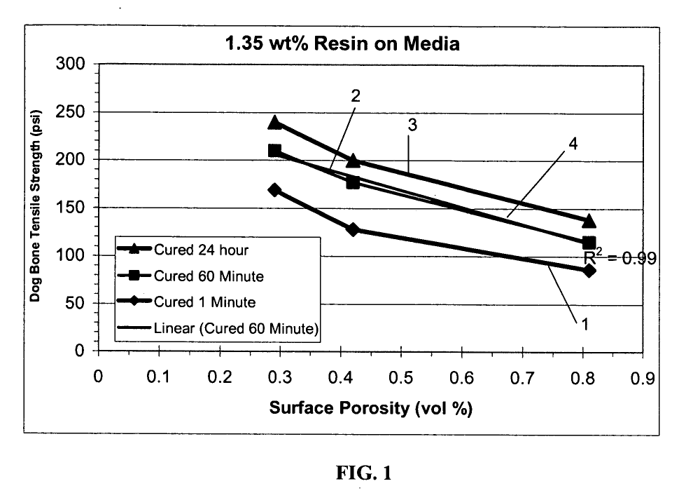

Turning now to FIG. 1, FIG. 1 illustrates tensile strength of dog bones formed from pellets made in the lab as described above that had a surface porosity of less than 1% by volume. The pellets were coated with a resin in the amount of about 1.35 wt % (based on total weight of the sintered pellets being coated). The resin used to prepare the dog bones relevant to FIG. 1 was phenolic urethane, which is commercially available from sources such as HA International. The tensile strengths at data points 1 were determined after curing of the dog bones for 1 minute. The tensile strengths at data points 2 were determined after 60 minutes of curing, and the tensile strengths at data points 3 were determined after 24 hours of curing. The data points at 4 illustrate the best fit for a 60 minute cure. The tensile strengths were determined at the reported times according to Procedures 3315-00-S, 3301-00-S and 3306-00-S of the American Foundry Society Mold and Core Handbook.

As illustrated in FIG. 1, the lower the surface porosity of the foundry media, the greater the tensile strength of the dog bone. Thus, an inverse relationship between the surface porosity of the media and the tensile strength of an object made from the media is illustrated. Foundry media made according to the methods described herein can be coated with more or less resin than the amount reported in FIG. 1, while still providing satisfactory strength to molds formed therefrom. For example, foundry media made according to the methods described herein and coated with a resin in an amount of from about 1.25% to about 1.50% by weight of the media, or in another example, from about 1.00% to about 2.00% by weight of the media, should produce dog bones having a 60 minute tensile strength in the range of from about 50 to about 300 psi. The strength of the dog bone is indicative of the strength of a mold formed from the media.

### EXAMPLE 4

Example 4 demonstrates that the strength of objects made from pellets having a low surface porosity increases as the surface porosity of the pellets decreases, and that the increase in strength is achieved without increasing the amount of resin used to coat the pellets.

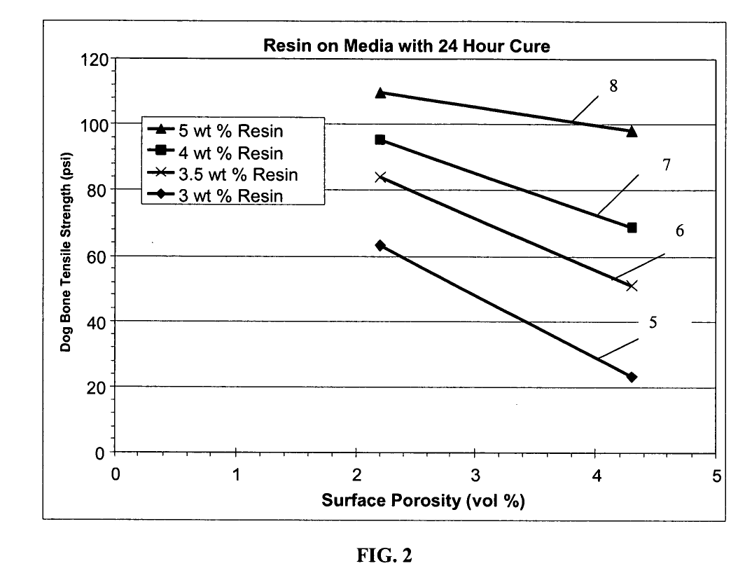

Turning now to FIG. 2, FIG. 2 illustrates tensile strength of dog bones made from pellets taken from the material made in Examples 1 and 2 that had less than 5% by volume surface porosity. The dog bones were formed by coating the sintered pellets with an amount of resin, based on total weight of the sintered pellets, of 3 wt % (line 5), 3.5 wt % (line 6), 4 wt % (line 7) and 5 wt % (line 8). The resin used to prepare the dog bones relevant to FIG. 2 was an alkaline phenolic resin (also called a CO₂ cured alkaline phenolic resin) commercially available from Foseco International under the tradename Ecolotec™.

The tensile strengths described in FIG. 2 were determined after 24 hours of curing according to procedures of the American Foundry Society Mold and Core Handbook as described in Example 3.

As illustrated in FIG. 2, for each weight percent of resin tested, the lower the porosity of the foundry media, the greater the tensile strength of the dog bone. The increase in strength was achieved without the need to increase the amount of resin used to form the dog bone.

### EXAMPLE 5

Example 5 demonstrates that the lower the surface porosity of the pellets, the less resin is required to produce objects of equal strength.

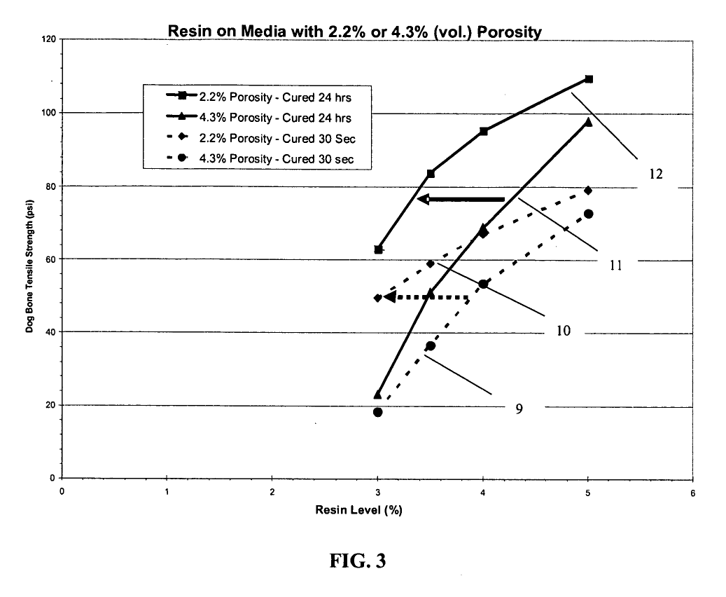

Turning now to FIG. 3, FIG. 3 illustrates tensile strength of dog bones made from pellets taken from the material made in Examples 1 and 2 coated with an alkaline phenolic resin (also called a CO₂ cured alkaline phenolic resin) commercially available from Foseco International under the tradename Ecolotec™.

The tensile strengths at line 9 correspond to pellets having about 4.3% by volume surface porosity, coated with the resin in an amount of about 3, 3.5, 4 and 5 wt % (based on total weight of the sintered pellets being coated), and cured for 30 seconds. The tensile strengths at line 10 correspond to pellets having about 2.2% by volume surface porosity, coated with the resin in an amount of about 3, 3.5, 4 and 5 wt % (based on total weight of the sintered pellets being coated), and cured for 30 seconds.

The tensile strengths at line 11 correspond to pellets having about 4.3% by volume surface porosity, coated with the resin in an amount of about 3, 3.5, 4 and 5 wt % (based on total weight of the sintered pellets being coated), and cured for 24 hours. The tensile strengths at line 12 correspond to pellets having about 2.2% by volume surface porosity, coated with the resin in an amount of about 3, 3.5, 4 and 5 wt % (based on total weight of the sintered pellets being coated), and cured for 24 hours.

As illustrated in FIG. 3, at 30 seconds and 24 hours, respectively, dog bones produced from pellets having lower porosity (lines 10 and 12) had a greater tensile strength than pellets having a higher porosity (lines 9 and 11). Moreover, pellets having a lower porosity require less resin than pellets having a higher porosity to form objects of comparable strengths.

For example, line 9 of FIG. 3 illustrates that to form objects having a strength of about 50 psi after 30 seconds of aging, pellets having 4.3% by volume porosity require almost 4 wt % (based on total weight of the pellets being coated) resin. In contrast, line 10 of FIG. 3 illustrates that pellets having 2.2% by volume porosity produced objects having a strength of about 50 psi (30 seconds of aging) with only about 3 wt % resin.

Similarly, line 11 illustrates that to form objects having a strength of about 75 psi or greater after 24 hours of aging, pellets having 4.3% by volume porosity require more than 4 wt % (based on total weight of the pellets being coated) resin. In contrast, line 12 illustrates that pellets having 2.2% by volume porosity produced objects having a strength of about 75 psi or more with about 20% less resin.

The lower amounts of resin required for the lower porosity foundry media would result in reductions in resin costs for a foundry using the lower porosity media. Additionally, lower resin levels will result in less gas generated during casting and therefore reduce chances for defects from excessive gas. Moreover, as compared to zircon sand, low porosity foundry media as described herein can be used to prepare molds having at least an equal tensile strength, with less resin. Zircon sand is a naturally-occurring foundry media having little to no porosity, and a density of about 168 lbs/ft³. Foundry media having a size similar to zircon sand, but a lower density than zircon sand, can be prepared according to methods described herein. Such media would require less resin to produce a mold of similar or greater tensile strength.

Alternatives

Other suitable raw materials for use with the methods described herein may contain alumina, silica, iron oxide and other compounds in amounts greater than or less than the raw materials described in Examples 1-2. Further, other suitable raw materials for use with the methods described herein include but are not limited to calcined, partially calcined, or uncalcined diaspore clay, burley clay, flint clay, bauxite and alumina or mixtures thereof

Besides the Eirich mixers described herein, other intensive mixers having a rotatable table and a rotatable impacting impeller are suitable, and such mixers can be operated as described herein, or according to methods known to those of ordinary skill in the art, for example, those described in U.S. Pat. No. 3,690,622, to Brunner.

Furthermore, spray dryers can used to form substantially round and spherical dried green pellets having a targeted moisture content as described herein. Spray dryers are known to those of ordinary skill in the art, and involve the atomization of a fluid feedstock into sprays of droplets, which are dried to individual pellets on contact with hot air. For use with the methods described herein, a fluid feedstock can be prepared with water and a calcined, uncalcined, or partially calcined aluminosilicate material, and optionally, a binder. The relative quantities of aluminosilicate material, water, and binder (if any) will be limited to those amounts that will make the slurry suitable for pumping through the atomizing equipment of the spray dryer. Suitable atomizing equipment includes but is not limited to a rotary wheel atomizer, a pressure nozzle atomizer and a dual fluid nozzle atomizer. Rotary wheel, pressure nozzle and dual fluid nozzle atomizers are known to those of ordinary skill in the art, and include those in spray dryers commercially available from a variety of sources, such as Niro, Inc. Nozzle design is known and understood by those of ordinary skill in the art, e.g. K. Masters: “Spray Drying Handbook”, John Wiley and Sons, New York (1979).

Dried green pellets are formed in the spray dryer as droplets of slurry exit the atomizing equipment and meet hot drying air in the drying chamber. A targeted moisture content for the green pellets could be achieved by at least one of controlling the residence time of the pellets in the spray dryer, controlling the operating temperature of the spray dryer, and controlling the air velocity of the spray dryer. Dried green pellets made by a spray dryer can be sintered according to methods described herein. In particular, sintering profiles as described herein can be employed to achieve sintered pellets having a surface porosity of less than 3% by volume.

Another embodiment for forming substantially round and spherical dried green pellets uses a fluid bed system, for example, as described in U.S. Pat. No. 4,440,866, the entire disclosure of which is hereby incorporated by reference herein. Such fluid bed systems are known to those of ordinary skill in the art. To use a fluid bed system with the methods described herein, a slurry comprising water, a calcined, uncalcined, or partially calcined aluminosilicate material, and optionally, a binder, is prepared. The relative quantities of aluminosilicate material, water, and binder (if any) will be limited to those amounts that will make the slurry suitable for pumping through atomizing equipment, such as the pressure atomizing nozzles or two-fluid nozzles described in U.S. Pat. No. 4,440,866. The atomizing equipment atomizes the slurry into a fluidizer, where dried green pellets are formed as the slurry droplets encounter a layer of already partly dried aluminosilicate pellets fluidized in a stream of drying air. A targeted moisture content for the green pellets could be achieved by at least one of controlling the residence time of the pellets in the fluidizer, controlling the operating temperature of the fluidizer, and controlling the air velocity of the fluidizer. Optionally, a moisture content is not targeted during formation of pellets in a fluid bed system, in which case the pellets are fed through a dryer where methods for target a moisture content are employed. For example, the pellets could be fed through a dryer prior to sintering as described in Examples 1-2. Dried green pellets made by a fluid bed system are sintered according to methods described herein. In particular, sintering profiles as described herein can be employed to achieve sintered pellets having a surface porosity of less than 3% by volume.

Suitable binders for use in the methods described herein include but are not limited to a corn starch, polyvinyl alcohol or sodium silicate solution, or a blend thereof. Liquid binders can also be used, and would preferably be added to the mixer instead of being pre-milled with the raw material. Bentonite and/or various resins or waxes known and available to those of ordinary skill in the art may also be used as a binder. Any suitable binder can be used in an amount of from about 0.25% to about 1.0% by weight of the raw material, or any other amount so as to assist formation of the pellets. Whether to use more or less binder than the values specifically described herein can be determined by one of ordinary skill in the art through routine experimentation.

The amount of water used in methods such as those described in Examples 1-2 can vary. In general, a suitable quantity of water is that amount which is sufficient to cause substantially round and spherical pellets to form upon mixing. Those of ordinary skill in the art will understand how to determine a suitable amount of water to use so that substantially round and spherical pellets are formed.

The initial rotation of the impeller as described in Examples 1-2 is optional. If employed, the initial rotation can be from about 5 to about 20 meters per second, followed by a higher tip speed in a range of from about 25 to about 35 meters per second. Those of ordinary skill in the art can determine whether to adjust the speed of rotations to values greater than or less than those described herein such that substantially round and spherical pellets of approximately the desired size are formed.

The amount of time to mix raw materials in the high intensity mixer can vary from those described in Examples 1-2 depending upon a number of factors, including but not limited to the amount of material in the mixer, speed of operation of the mixer, the amount of water fed to the mixer, and the desired pellet size. Those of ordinary skill in the art can determine whether the mixing time should be greater than or less than the times described herein such that substantially round and spherical pellets of approximately the desired size are formed.

Besides the rotary dryer used in Examples 1-2, other types of drying equipment that could be suitable for use with the present methods include but are not limited to fluid bed dryers, direct heat dryers, compressed air dryers and infrared dryers. Commercial sources for dryers described herein are known to those of ordinary skill in the art.

The amount of residence time of the pellets in the dryer, the operating temperature of the dryer, and the air velocity of the dryer can vary from those described in Examples 1-2 depending on a number of factors. For example, the operating temperature of the dryer and the residence time of the pellets in the dryer can adjusted to produced dried green pellets having a targeted moisture content after discharge from the dryer. In addition, a suitable air velocity will be high enough such that the pellets will have a targeted moisture content after discharge from the dryer, but low enough such that the amount of pellets lost to a dust collector or other type of exhaust from the dryer is not excessive. A targeted moisture content for green pellets can be that content that would result in a desired porosity for pellets after sintering. As described herein, green pellets having a moisture content of about 6% or less by weight would have a surface porosity of about 3% or less by volume when the pellets were fired to their final state. Thus, in certain embodiments, a targeted moisture content for green pellets could be less than about 6% by weight, less than about 5% by weight, less than about 4% by weight, less than about 2% by weight, or less than about 1% by weight. In other embodiments, a targeted moisture content for green pellets could be that content that would result in sintered pellets having a porosity on its surface of from about 1% to about 4% by volume. In still other embodiments, a targeted moisture content for green pellets could be greater than 6% by weight, for example, between 6 and 10% by weight.

The operating temperature of the kiln in which green pellets are sintered, and the residence time of the green pellets in the kiln can also vary from those described in Examples 1-2. For example, a rotary kiln can be operated at a temperature ranging from about 1,400° C. (2,552° F.) to about 1,550° C. (2,822° F.), and the residence time can be in the range of from about 30 to about 90 minutes. Other times and temperatures may also be employed.

Optionally, green pellets can be screened prior to sintering to remove pellets that are under and over a desired size. If screening is employed, only the dried pellets having the desired size are sent to a rotary kiln for sintering. For example, green pellets can be screened so that pellets in a range between about 6 and 270 U.S. Mesh will be produced after sintering. According to still other examples, the desired size for sintered pellets is in a range of from about 3.35 to about 0.05 millimeters. According to yet other examples, the desired size is expressed as a grain fineness number (GFN) in a range of from about 15 to about 300, or from about 30 to about 110, or from about 40 to about 70.

The methods described in Examples 1-2 can also be used to make pellets having a bulk density of from about 1.33 g/cc to about 2.05 g/cc, and/or an ASG of from about 2.50 to about 3.70. Moreover, the methods described in Examples 1-2 can be used to produce sintered pellets having an alumina content in a range of from about 44% to about 85% by weight. In general, the ratio of alumina to silica in the sintered pellets can fall in the range of 17:1 to 0.9:1 by weight, with a balance, where applicable, of other compounds (e.g., TiO₂, ZrO₂, CaO, MgO and K₂O).

In addition to the resins described in Examples 3-5, other resins suitable for coating a foundry media and forming a mold therefrom are known to those of ordinary skill in the art, and include but are not limited to phenolic esters, lignin and phenolic alkaline resins.

It will be obvious to those skilled in the art that the invention described herein can be essentially duplicated by making minor changes in the material content or the method of manufacture. To the extent that such material or methods are substantially equivalent, it is intended that they be encompassed by the following claims.

1. A method for forming a foundry media comprising:
mixing water and aluminosilicate material to form substantially round and spherical green pellets, at least a portion of which have a size between about 6 and about 270 U.S.
Mesh;
controlling the moisture content of the green pellets during drying of the green pellets to a targeted moisture content; and
sintering the dried green pellets to a surface porosity of less than about 3% by volume;
wherein the surface porosity of the sintered pellets has a direct relationship with the targeted moisture content of the dried green pellets.

2. The method of claim 1 wherein the targeted moisture content of the dried green pellets is selected from the group consisting of less than about 6% by weight, less than about 5% by weight, less than about 4% by weight, less than about 2% by weight, and less than about 1% by weight.

3. The method of claim 1 wherein at least a portion of the green pellets have a size selected from about 1.0 to about 0.05 millimeters, or a grain fineness number (GFN) of from about 15 to about 300.

4. The method of claim 1 wherein at least a portion of the green pellets have a bulk density of from about 1.33 g/cc to about 2.05 g/cc.

5. The method of claim 1 wherein the sintered pellets have a surface porosity of less than about 2% by volume.

6. The method of claim 1 wherein the aluminosilicate material is selected from the group consisting of calcined, partially calcined, or uncalcined kaolin clay, diaspore clay, burley clay, flint clay, bauxite and alumina, and mixtures thereof.

7. The method of claim 1 further comprising mixing a binder selected from the group consisting of starch, polyvinyl alcohol, sodium silicate solution, and bentonite with the water and the aluminosilicate material.

8. The method of claim 7 wherein the binder comprises from about 0.25% to about 1.0% by weight of the aluminosilicate material.

9. The method of claim 1 further comprising:
operating a dryer at an operating temperature and at an air velocity;
feeding the green pellets to the dryer;
providing a residence time for the green pellets in the dryer; and
controlling the moisture content of the green pellets by performing at least one of:
controlling the residence time of the pellets in the dryer;
controlling the operating temperature of the dryer;
controlling the air velocity of the dryer; and
feeding the green pellets to the dryer at a substantially uniform rate of feed.

10. The method of claim 1 wherein the sintering comprises sintering the dried green pellets in a rotary kiln operating at a temperature of from about 1,400° C. (2,552° F.) to about 1,550° C. (2,822° F.), and at a residence time of from about 30 to about 90 minutes.

11. The method of claim 1 wherein the sintered pellets have at least one of a bulk density of from about 1.33 g/cc to about 2.05 g/cc, and an ASG of from about 2.50 to about 3.70.

12. The method of claim 1 wherein the sintering comprises a sintering profile selected from the group consisting of:
subjecting the dried green pellets to heat at an initial rate up to an initial sintering temperature, followed by increasing the initial rate of heating up to a final sintering temperature, wherein the initial rate of heating is about 2 to about 10% per minute of the initial sintering temperature;
maintaining an exit air temperature during sintering at a temperature of about 600° C. (1112° F.) or less; and
selecting a peak sintering temperature, and maintaining an exit air temperature during sintering at a temperature of about 40% or less of the peak sintering temperature.

13. The method of claim 12 wherein the initial sintering temperature is about 250° C., and the initial rate of heating is about 16° C. per minute.

14. The method of claim 1 wherein the forming of the substantially round and spherical green pellets comprises one of:
mixing the water and aluminosilicate material in a high intensity mixer;
mixing the water and aluminosilicate material to form a slurry and atomizing the slurry into substantially round and spherical green pellets in a spray dryer; and
mixing the water and aluminosilicate material to form a slurry and atomizing the slurry into substantially round and spherical green pellets in a fluid bed system.

15. A method for forming a foundry media comprising:
mixing water and aluminosilicate material to form substantially round and spherical green pellets; and
sintering the green pellets to a surface porosity of less than about 3% by volume, wherein the sintering follows a profile selected from the group consisting of:
subjecting the green pellets to heat at an initial rate up to an initial sintering temperature, followed by increasing the initial rate of heating up to a final sintering temperature, wherein the initial rate of heating is about 2 to about 10% per minute of the initial sintering temperature;
maintaining an exit air temperature of equipment in which the green pellets are sintered at a temperature of about 600° C. (112° F.) or less; and
selecting a peak sintering temperature, and maintaining an exit air temperature of equipment in which the green pellets are sintered at a temperature of about 40% or less of the peak sintering temperature.

16. The method of claim 15 further comprising:
drying the green pellets prior to sintering to a moisture content of less than about 6% by weight.

17. The method of claim 16 further comprising:
operating a dryer at an operating temperature and at an air velocity;
feeding the green pellets to the dryer;
providing a residence time for the green pellets in the drying; and
controlling the moisture content of the green pellets by performing at least one of:
controlling the residence time of the pellets in the dryer;
controlling the operating temperature of the dryer;
controlling the air velocity of the dryer; and
feeding the green pellets to the dryer at a substantially uniform rate of feed.

18. The method of claim 15 wherein at least a portion of the green pellets have a size selected from about 1.0 to about 0.05 millimeters, or a grain fineness number (GFN) of from about 15 to about 300.

19. The method of claim 15 wherein the aluminosilicate material is selected from the group consisting of calcined, partially calcined, or uncalcined kaolin clay, diaspore clay, burley clay, flint clay, bauxite and alumina, and mixtures thereof.

20. The method of claim 15 wherein the sintered pellets have at least one of a bulk density from about 1.33 g/cc to about 2.05 g/cc, and an ASG of from about 2.50 to about 3.70.

21. The method of claim 15 wherein the forming of the substantially round and spherical green pellets comprises one of:
mixing the water and aluminosilicate material in a high intensity mixer;
mixing the water and aluminosilicate material to form a slurry and atomizing the slurry into substantially round and spherical green pellets in a spray dryer; and
mixing the water and aluminosilicate material to form a slurry and atomizing the slurry into substantially round and spherical green pellets in a fluid bed system.

22. A method for forming a mold comprising:
mixing water and aluminosilicate material to form substantially round and spherical green pellets;
controlling the moisture content of the green pellets during drying so that sintering of the dried green pellets produces sintered pellets having a targeted surface porosity;
coating the sintered pellets with a resin; and
shaping the mold from the resin-coated pellets; wherein the surface porosity of the sintered pellets has at least one of:
a direct relationship with the moisture content of the dried green pellets;
a direct relationship with the amount of resin used to coat the sintered pellets;
an inverse relationship to the strength of the mold.

23. The method of claim 22 wherein the moisture content of the dried green pellets is controlled to a value selected from the group consisting of less than about 6% by weight, less than about 5% by weight, less than about 4% by weight, less than about 2% by weight, and less than about 1% by weight.

24. The method of claim 22 wherein at least a portion of the green pellets have a size selected from about 1.0 to about 0.05 millimeters, or a grain fineness number (GFN) of from about 15 to about 300.

25. The method of claim 22 wherein at least a portion of the green pellets have a bulk density of from about 1.33 g/cc to about 2.05 g/cc.

26. The method of claim 22 wherein the sintered pellets have a surface porosity of less than about 2% by volume or less than about 3% by volume.

27. The method of claim 22 wherein the resin is selected from the group consisting of phenolic esters, lignin and phenolic alkaline resins.

28. A product comprising:
substantially round and spherical sintered pellets comprising an aluminosilicate material, and having a surface porosity of less than about 3% by volume.

29. The product of claim 28 wherein the sintered pellets have a porosity of less than about 2% by volume or less than about 1% by volume.

30. The product of claim 28 wherein the aluminosilicate material is selected from the group consisting of calcined, partially calcined, or uncalcined kaolin clay, diaspore clay, burley clay, flint clay, bauxite and alumina, and mixtures thereof.

31. The product of claim 28 wherein the sintered pellets have at least one of a bulk density from about 1.33 g/cc to about 2.05 g/cc, and an ASG of from about 2.50 to about 3.70.

32. The product of claim 28 further comprising:
a resin coating the sintered pellets, wherein the resin-coated pellets have been shaped into a mold.

33. The product of claim 32 wherein the resin is selected from the group consisting of phenolic esters, lignin and phenolic alkaline resins.
